(19) United States
(12) Patent Application Publication
(10) Pub. No.: US 2006/0121272 A1
(43) Pub. Date: Jun. 8, 2006

(54) Thermo-activated adhesive material for fpcb agglutinations

(75) Inventors: Marc Husemann, Hamburg (DE); Christian Ring, Hamburg (DE); Dieter Zimmermann, Jork (DE)

Correspondence Address: NORRIS, MCLAUGHLIN & MARCUS, P.A., 875 THIRD AVE, 18TH FLOOR, NEW YORK, NY, 10022, US

(73) Assignee: Tesa AG, Hamburg (DE)

(21) Appl. No.: 10/543,795

(22) PCT Filed: Jan. 27, 2004
(86) PCT No.: PCT/EP04/00679

§ 371 Date: Dec. 29, 2005

(30) Foreign Application Priority Data
Jan. 29, 2003 (DE) 103 03 518.4
May 30, 2003 (DE) 103 17 403.6
May 30, 2003 (DE) 103 24 737.8

(51) Int. Cl. C09J 163/00; B32B 7/12

(52) U.S. Cl. 428/343; 156/308.2; 156/330

(57) ABSTRACT

An adhesive sheet comprising (i) at least one thermoplastic polymer and/or one thermoplastic elastomer, (ii) at least one resin, and (iii) at least one organically modified phyllosilicate and/or bentonite.

The invention relates to a heat-activable adhesive of low fluidity at high temperatures for bonding flexible printed circuit board laminates.

Adhesive tapes are widespread processing aids in numerous technical fields. Particularly for use in the electronics industry the requirements imposed on adhesive tapes are very exacting.

At the present time there is a trend within the electronics industry to ever narrower, lighter, and faster components. In order to fulfill these parameters, the requirements imposed on the manufacturing operation are becoming evermore stringent. This also pertains to the flexible printed circuit boards (FPCBs), which are used very frequently for the electrical contacting of IC chips or conventional printed circuit boards.

Flexible printed circuit boards are represented in a host of electronic devices, such as, for example, cell phones, car radios, computers, etc. FPCBs are composed of layers of copper and polyimide, with polyimide being bonded if appropriate to the copper foil.

For the use of the FPCBs they are bonded to substrates or else bonded to one another. In the latter case polyimide films are bonded to one another.

The adhesives used for bonding FPCBs are generally heat-activable adhesives which release no volatile constituents and can also be used in a high temperature range.

Additionally it is necessary for the heat-activable adhesive, following temperature activation, to be self-crosslinking, since in general the bonded FPCBs must also still be solder bath resistant.

Pure thermoplastics, which are used as heat-activable adhesives for a range of bonds, become soft again at high temperatures and therefore lack solder bath resistance. Pure thermoplastics are therefore unsuitable as a basis for the adhesives for the abovementioned sphere of application. Taken per se, however, thermoplastic adhesives would be preferable for the bonding operation, since they can be activated within a few seconds and the adhesive bond would be established with corresponding rapidity.

Further heat-activable adhesive tapes, such as the block copolymers described in U.S. Pat. No. 5,478,885 and based on epoxidized styrene-butadiene or styrene-isoprene, possess the disadvantage that they require very long cure times for complete curing and hence significantly slow the processing operation. The same applies to other epoxy-based systems, as described in WO 96/33248, for example.

Phenolic resin-based heat-activable adhesive tapes are generally excluded, since in the course of curing they release volatile constituents and hence lead to blistering.

A further general disadvantage of the known adhesive systems described above is the excessive fluidity at elevated temperature. The FPCBs are bonded at temperatures of around 200° C. under a high pressure. While the bond is curing the adhesive must not run. For certain applications, also, drilling and milling is performed in the component and hence also in the adhesive sheet prior to pressing and curing. The modifications must be retained in the adhesive as well, and so the adhesive must not run during the operation. Otherwise an unwanted consequence would be at subsequent contacts made via the drill holes, with soldering tin, for example, would function only to a restricted degree, or not at all.

It was therefore an object of the invention to satisfy the demand for a heat-activable adhesive system which is self-crosslinking and solder bath resistant, possesses low fluidity at temperatures above 120° C., and adheres well to polyimide.

This object is achieved, surprisingly, by means of an adhesive sheet as characterized in more detail in the main claim. The subclaims provide advantageous developments of the subject matter of the invention.

The invention accordingly provides an adhesive sheet comprising (i) at least one thermoplastic polymer or one thermoplastic elastomer, (ii) at least one (tackifying) resin, and (iii) at least one organically modified phyllosilicate and/or bentonite.

The general expression “adhesive sheet” embraces, for the purposes of this invention, all sheetlike structures, such as films extended in the two other dimensions, sections cut from or out of films, tapes (extended length, limited width), tape sections, labels, diecuts, and the like, it being possible for the structures to have regular or irregular shapes.

An adhesive sheet which has proven particularly advantageous is one comprising the following components:
i) a thermoplastic polymer or an elastomer with a fraction of 25%-70% by weight
ii) one or more tackifying phenolic resins with a fraction of 0-30% by weight
iii) epoxy resins, advantageously with hardeners, possibly also with accelerators, with a fraction of 5%-60% by weight
iv) organically modified phyllosilicates or bentonites with a fraction of 1%-15% by weight.

The reactive sheet is advantageously a mixture comprising reactive resins, which crosslink at room temperature and form a three-dimensional polymer network of high strength, and comprising thermoplastic compounds, especially elastomers of permanent elasticity, which act to counter embrittlement of the product.

The elastomer may come preferably from the group of the polyolefins, polyesters, polyurethanes or polyamides or may be a modified rubber, such as nitrile rubber, for example.

The particularly preferred thermoplastic polyurethanes (TPUs) are known reaction products of polyester polyols or polyether polyols and organic diisocyanates, such as diphenylmethane diisocyanate. They are composed of predominantly linear macro molecules. Products of this kind are available commercially, mostly in the form of elastic pellets, from Bayer AG under the trade name “Desmocoll”, for example.

Synthetically prepared nitrile rubbers can also be used as elastomers. In this case, for example, Hycar™ grades from BF Goodrich, for example, are used. Suitable nitrile rubbers are also offered, furthermore, under the trade name Nipol™ by Nippon Zeon.

Polyesters used are, with particular preference, amorphous grades. Here, for example, various grades are offered under the trade name Griltex™ by Emsland Chemie.

The adhesive sheet advantageously further comprises substances which in particular under elevated pressure and/or elevated temperature serve as hardeners for at least one of the resins that are present.

By combining elastomers with selected compatible resins it is possible to reduce the softening temperature of the adhesive sheet sufficiently. In parallel with this there is an increase in the adhesion. Examples of resins which have been found suitable include rosins, hydrocarbon resins, and coumarone resins.

Epoxy resins are normally understood to include not only oligomeric compounds having more than one epoxide group per mole but also the thermosets produced from such compounds. For the purposes of the invention, the entire group of the epoxy compounds is to be comprehended. Thus it is possible to use the corresponding monomers, oligomers or polymers which contain at least two epoxy groups. Polymeric epoxy resins may be aliphatic, cycloaliphatic, aromatic or heterocyclic in nature.

The molecular weight Mₙ of the added epoxy resins is preferably chosen between 100 and 25 000 g/mol.

Epoxy resins which can be used with advantage in accordance with the invention include, for example, glycidyl esters and/or the reaction products of epichlorohydrin and at least one of the following compounds:

Bisphenol A, the reaction product of phenol and formaldehyde (Novolak resins), p-aminophenol.

Preferred commercial examples are, e.g., Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071 and HPT™ 1079, likewise from Shell Chemical.

Examples of commercial aliphatic epoxy resins are, e.g., vinylcyclohexane dioxides, such as ERL-4206, ERL-4221, ERL 4201, ERL-4289, or ERL-0400 from Union Carbide Corp.

Through the blending with epoxy resins in combination with the corresponding hardener an aftercure is obtained under temperature and pressure in the course of bonding: for example, when the bonded FPCB is passed through a solder bath.

Substances termed hardeners are substances which are added to crosslinkable resins (prepolymers) in order to cure (crosslink) them.

As a result of the chemical crosslinking reaction of the resins, high strengths are achieved between the adhesive film and the polyimide film of the FPCB, and a high internal strength is obtained in the product.

The addition of these reactive resin/hardener systems leads advantageously also to a reduction in the softening temperature of the abovementioned polymers, which lowers their processing temperature and processing speed.

With advantage in accordance with the invention it is possible to use for the adhesive sheet, as hardener systems for epoxy resins and/or phenolic resins and/or any other added resins, all of the hardeners that are known to the skilled worker and lead to reaction with the corresponding resins. All formaldehyde donors come into this category, such as hexamethylenetetraamine, for example. Additionally use may also be made of acid anhydrides, cationic crosslinkers, guanidines, such as dicyandiamide, for example, or peroxides. In addition it is also possible to use combinations of these crosslinkers. If desired, accelerators as well can be used, such as, inter alia, imidazoles, for example. Examples of suitable accelerators include imidazoles, available commercially under 2M7, 2E4MN, 2PZ-CN, 2PZ-CNS, P0505, L07N from Shikoku Chem. Corp. or Curezol 2MZ from Air Products. In addition it is also possible to use amines, especially tertiary amines, for acceleration.

A further constituent of the inventive pressure-sensitive adhesive are organically modified phyllosilicates or bentonites. Particularly preferred for use are silicates which are available under the trade name Bentone™ (from Elementis Specialties). Preference is given to using Bentone™ grades which exhibit low outgassing at 200° C.—preferably less than 200 μg of volatile constituents at a temperature of 200° C. over a period of 1 h—and also a low chloride fraction—preferably of less than 0.2% by weight, more preferably of less than 0.1% by weight—

High chloride fractions may adversely affect the electrical conductivity of the copper conductor tracks. High outgassing constituents, in contrast, lead to deformation of the FPCB laminates after curing, and reduce the solder bath resistance.

Other compounds which can be added as a reactive resin component also include, optionally, phenolic resins, such as YP 50 (from Toto Kasei), PKHC (from Union Carbide Corp.) and/or BKR 2620 (from Showa Union Gosei Corp.), for example.

As reactive resins it is optionally possible likewise to use polyisocyanates, such as Coronate™ L (from Nippon Polyurethan Ind.), Desmodur™ N3300 or Mondur™ 489 (from Bayer), in addition or alternatively to the phenolic resins.

The composition for the adhesive sheet can be varied within a wide framework by altering the type and proportion of raw materials. It is also possible to obtain further product properties such as, for example, color, thermal or electrical conductivity by means of targeted additions of colorants, fillers and/or carbon powders and/or metal powders. The adhesive sheet preferably has a thickness of 5 to 100 μm, more preferably of 10 and 50 μm.

To produce the adhesive sheet the composition forming the sheet is coated, as a solution or from the melt, onto a flexible substrate (release film, release paper) and if appropriate is dried, so that the composition can easily be removed from the substrate again. In accordance with appropriate converting it is possible for diecuts, sections from a roll, or other bodies shaped from this adhesive sheet to be adhered, at room temperature or at slightly elevated temperature, to the substrate that is to be bonded (polyimide).

In a further version the adhesive is coated onto a polyimide carrier. Adhesive sheets of this kind can then be used for masking copper conductor tracks for FPCBs.

The admixed reactive resins ought preferably not yet to enter into any chemical reaction at the slightly elevated temperature. It is not necessary for the bonding to take place as a one-stage process; instead, for the sake of simplicity, as in the case of bonding with commercially customary pressure-sensitive adhesive tapes, the adhesive sheet can first be attached to one of the two substrates, by carrying out thermal lamination. During the actual operation of hot bonding to the second substrate (second polyimide sheet of the second FPCB), the resin then undergoes further or partial cure and the adhesive joint attains the high bond strength, which is situated well above that of known pressure-sensitive adhesive systems.

The adhesive sheet is particularly suitable, accordingly, for a hot pressing process at temperatures above 80° C., preferably above 100° C., more preferably above 120° C.

Unlike other adhesive sheets, which consist mostly of pure epoxy resins, the adhesive sheet of the invention has a high elastic component as a result of the high elastomer fraction (rubber fraction). As a result of this viscoelastic behavior, the flexible movements of the FPCBs can be compensated to particularly good effect, so that even high stresses and peeling movements are effectively withstood.

Furthermore, the specific phyllosilicates minimize the fluidity at high temperatures.

Moreover, as a result of the high viscoelastic component, the adhesive sheet possesses an advantage over other heat-activable compositions. Contacting is often achieved by drilling holes through the adhesive sheet. The problem here is that existing heat-activable adhesives flow into the holes and hence disrupt the contacting. With the inventive use of the adhesive sheets described above, this problem occurs only to a greatly reduced extent, if at all.

As well as the bonding of FPCBs based on polyimide, bonding can also take place to polyethylene naphthalate (PEN)- and polyethylene terephthalate (PET)-based FPCBs. In these cases as well a high bond strength is achieved with the adhesive sheet.

### EXPERIMENTS

The invention is described below, without wishing to impose any unnecessary restriction through the choice of the examples.

The following test methods were employed.

Test Methods

Production of the Thermally Activable Adhesive Sheet

### Example 1

A mixture of 50 g of nitrile rubber (Breon® 41, from Zeon), 50 g of epoxy resin (Rütapox™ 166, from Bakelite AG), 5 g of organic phyllosilicate. (Bentone 38®, from Elementis Specialities), and 3.4 g of dicyandiamide is dissolved in methyl ethyl ketone and coated from solution onto a release paper siliconized at 1.5 g/m², and at 90° C. the coated paper is dried at this temperature for 10 minutes. The thickness of the adhesive layer was 25 μm.

### Example 2

A mixture of 60 g of nitrile rubber (Breon® 41, from Zeon), 40 g of epoxy resin (Rütapox™ 166, from Bakelite AG), 5 g of organic phyllosilicate (Bentone 38®, from Elementis Specialities), and 3 g of dicyandiamide is dissolved in methyl ethyl ketone and coated from solution onto a release paper siliconized at 1.5 g/m², and at 90° C. the coated paper is dried at this temperature for 10 minutes. The thickness of the adhesive layer was 25 μm.

### Example 3

A mixture of 100 g of polyester (Griltex®, Emsland Chemie), 130 g of epoxy resin (Rütapox™ 164, from Bakelite AG), 24 g of organic phyllosilicate (Bentone 38®, from Elementis Specialities), and 9 g of dicyandiamide is dissolved in methyl ethyl ketone and coated from solution onto a release paper siliconized at 1.5 g/m², and at 90° C. the coated paper is dried at this temperature for 10 minutes. The thickness of the adhesive layer was 25 μm.

### Example 4

In a Z-arm kneader a mixture of 100 g of polyester (Griltex®, Emsland Chemie), 130 g of epoxy resin (Rütapox™ 164, from Bakelite AG), 24 g of organic phyllosilicate (Bentone 38®, from Elementis Specialities), and 9 g of dicyandiamide is kneaded for 4 h and then coated via an extrusion die onto a release paper siliconized at 1.5 g/m². The thickness of the adhesive layer was 25 μm.

The reference example (R) used in the comparative investigations was a commercially available adhesive sheet, namely Pyralux® LF001 from DuPont, with a film thickness of 25 μm.

Bonding of FPCBs with the Adhesive Sheet

Two FPCBs were bonded using in each case the adhesive sheets produced in accordance with examples 1 to 4, and also using the reference sheet (R) (Pyraluxe® LF001, from DuPont). For this purpose the adhesive sheet was laminated onto the polyimide film of the polyimide/copper foil/polyimide FPCB laminate at 100° C. Subsequently this operation was repeated with a second polyimide film of a further FPCB to produce a bonded joint between two polyimide/copper foil/polyimide laminates, with the polyimide films being bonded to one another in each case. The assembly was cured by subjecting it to compression in a heatable press from Bürkle at 170° C. for 30 minutes under a pressure of 50 N/cm².

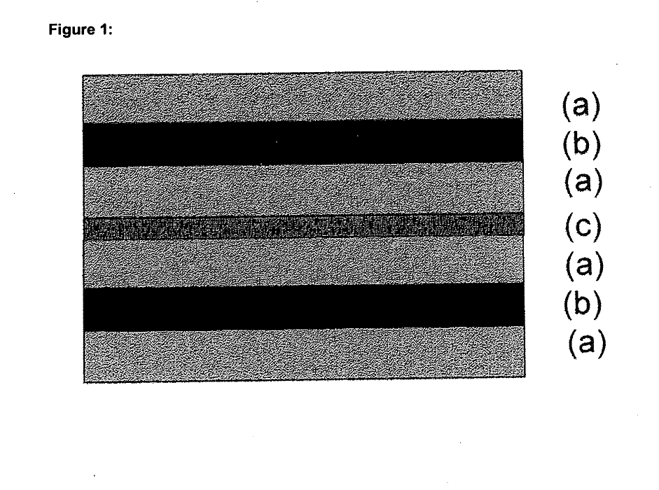

The bonds thus produced have the construction depicted in FIG. 1, where (a) denotes in each case a polyimide layer, (b) in each case a copper layer, and (c) the adhesive sheet. One assembly (a-b-a) of a copper layer (b) with a polyimide layer (a) on either side constitutes one FPCB unit.

Test Methods

The properties of the adhesive sheets produced in accordance with the examples specified above were investigated using the following test methods.

A. T-Peel Test with FPCB

Using a tensile testing machine from Zwick, the FPCB/adhesive sheet/FPCB assemblies produced in accordance with the process described above (FIGURE) were peeled from one another at an angle of 180° and at a speed of 50 mm/min, and the force in N/cm was measured. The measurements were carried out at 20° C. and 50% humidity. Each measurement value was determined three times and averaged.

B. Temperature Stability

A 1 kg weight was affixed to one end of the FPCB assemblies produced in accordance with the process described above (FIGURE), and the assembly was suspended from the other end. The test is passed if the assembly holds the weight in a drying cabinet at a temperature of 70° C. for longer than 8 hours.

C. Solder Bath Resistance

The FPCB assemblies bonded in accordance with the process described above (FIGURE) were immersed fully for 10 seconds into a hot solder bath at 288° C. The bond was evaluated as being solder bath resistant if there were no air bubbles formed which caused the polyimide film of the FPCB to inflate. The test was evaluated as failed if there was even slight blistering.

D. Bond Strength

The bond strength was measured in analogy to DIN EN 1465. The measurements were reported in N/mm².

Results:

For adhesive assessment of the abovementioned examples the T-peel test with FPCB material was carried out first of all. The corresponding measured values are listed in table 1.

TABLE 1

| | Test A/T-peel test |
|---|---|
| | [N/cm] |
| Example 1 | 8.8 |
| Example 2 | 7.2 |
| Example 3 | 9.5 |
| Example 4 | 9.2 |
| Reference example R | 6.5 |

Table 1 shows that with examples 1 to 4 very high bond strengths were achieved after just 30 minutes' curing. The reference example R shows lower bond strengths.

Another important constituent of the inventive adhesive is the minimized fluidity at elevated temperatures. Therefore test method B was carried out with all of the examples. The results are summarized in table 2.

TABLE 2

| | Test B/temperature stability |
|---|---|
| Example 1 | passed |
| Example 2 | passed |
| Example 3 | passed |
| Example 4 | passed |
| Reference example R | failed |

Table 2 reveals that the examples 1 to 4, blended with Bentone™, have only a very low fluidity and are therefore able to withstand high loads at high temperatures.

A further criterion for the application of adhesive sheets for bonding FPCBs is the solder bath resistance (test method C).

Table 3 lists the results for solder bath resistance.

TABLE 3

| | Test C/solder bath resistance |
|---|---|
| Example 1 | passed |
| Example 2 | passed |
| Example 3 | passed |
| Example 4 | passed |
| Reference example R | passed |

From the results it is apparent that all the examples are solder bath resistant and hence meet the requirements of the FPCB industry.

To investigate the ability of the adhesive sheets to withstand a shearing load, the bond strengths were likewise measured. Table 4 lists the corresponding values.

TABLE 4

| | Test D/bond strength |
|---|---|
| | [N/mm²] |
| Example 1 | 13.6 |
| Example 2 | 15.0 |
| Example 3 | 12.7 |
| Example 3 | 13.5 |
| Reference example R | 6.0 |

From table 4 it is apparent that the adhesive sheets 1 to 4 of the invention possess a significantly higher bond strength than the reference example R.

1. An adhesive sheet comprising
(i) at least one thermoplastic polymer and/or one thermoplastic elastomer,
(ii) at least one resin, and
(iii) at least one organically modified phyllosilicate and/or bentonite.

2. The adhesive sheet of claim 1, comprising
(i) a thermoplastic polymer or elastomer with a mass fraction of 25% to 70% by weight,
(ii) epoxy resins with a mass fraction of 5% to 60% by weight,
(iii) one or more organically modified phyllosilicates and/or bentonites with a total mass fraction of 1% to 15% by weight,
(iv) optionally, one or more phenolic resins with a mass fraction of up to 30% by weight.

3. The adhesive sheet of claim 2, further comprising substances which under elevated pressure and/or elevated temperature serve as hardeners of the epoxy resins and/or phenolic resins.

4. The adhesive sheet of claim 1, wherein said phyllosilicates and/or bentonites have less than 200 μg of volatile constituents at a temperature of 200° C. over a period of 1 h.

5. The adhesive sheet of claim 1, wherein said phyllosilicates and/or bentonites have a chloride content of less than 0.2% by weight.

6. The adhesive sheet of claim 1, further comprising accelerators, colorants, fillers, carbon powders and/or metal powders.

7. A method of adhesively bonding plastics parts, which comprises bonding said plastic parts with a thermally activable adhesive sheet comprising
(i) at least one thermoplastic polymer or a modified rubber,
(ii) at least one resin, and
(iii) at least one organically modified phyllosilicate and/or bentonite.

8. The method of claim 7 wherein said plastic parts are flexible printed circuit boards.

9. A method for bonding an object to polyimide, which comprises bonding said object to polyimide with a thermally activable adhesive sheet comprising
(i) at least one thermoplastic polymer or a modified rubber,
(ii) at least one resin, and
(iii) at least one organically modified phyllosilicate and/or bentonite.

10. The adhesive sheet of claim 5, wherein said chloride content is less than 0.1% by weight
